(19) United States
(12) Patent Application Publication
(10) Pub. No.: US 2020/0302293 A1
(43) Pub. Date: Sep. 24, 2020

(54) METHODS AND SYSTEMS FOR FIELD DEVELOPMENT DECISION OPTIMIZATION

(71) Applicant: ExxonMobil Research and Engineering Company, Annandale, NJ (US)

(72) Inventors: Kuang-Hung Liu, Basking Ridge, NJ (US); Michael H. Kovalski, Summit, NJ (US); Myun-Seok Cheon, Whitehouse Station, NJ (US); Xiaohui Wu, Sugar Land, TX (US)

(21) Appl. No.: 16/785,855

(22) Filed: Feb. 10, 2020

Related U.S. Application Data
(60) Provisional application No. 62/820,957, filed on Mar. 20, 2019.

(51) Int. Cl. G06N 3/08; G05B 19/4155

(52) U.S. Cl. CPC G06N 3/08; G05B 2219/45129; G05B 19/4155

(57) ABSTRACT

An example apparatus for optimizing output of resources from a predefined field can comprise an Artificial Intelligence (AI)-assisted reservoir simulation framework configured to produce a performance profile associated with resources output from the field. The apparatus can further comprise an optimization framework configured for determining one or more financial constraints associated with the field, the optimization framework providing the one or more financial constraints to the AI-assisted reservoir simulation framework, and a deep learning framework configured for training a neural network for use by the optimization framework. The AI-assisted reservoir simulation framework determines, as an output, a plurality of actions for optimizing output of resources from the field.

### CROSS-REFERENCE TO RELATED APPLICATIONS

This application claims the benefit of U.S. Provisional Application No. 62/820,957, filed on Mar. 20, 2019, the disclosure of which is incorporated herein by reference in its entirety.

### BACKGROUND OF THE INVENTION

In the upstream oil and gas industry, once a hydrocarbon-bearing field has been identified, it is important to create a field development plan, including how much financial investment will be put into the field, what sorts of infrastructure will be used, what sort of capacity is expected from the field, and the like. Field development planning decision processes refer to a business practice to determine an optimal investment strategy for developing an oil field. For example, optimization can include determining optimal infrastructure capacities and the right timing and sequence of investments. In order to make a judicious decision, it is required to consider many factors together. This aspect makes the decision process challenging. For example, in order to determine infrastructure characteristics such as processing or storage capacities, it is very important to consider related depletion plans, which govern the number of wells and their locations and timings and their production schedules, which are controlled by a well management process. In addition, these field development plans are dependent on geological scenarios. Intricate connections among many variables are one source of the challenges in field development.

The many variables are typically used as input to a reservoir simulator, which then generates a forecast of the production profile constrained by several assumptions. In this way, a production engineer must consider several hypotheses to achieve a best guess for the field development problem under study. Also, each hypothesis can generate additional hypotheses, and so, generating a hypothesis tree where the main common connection is the central problem. The solution of this problem requires the effort of several people as well as computer work and physical time. Often, in the industry, there is insufficient time and/or personnel to perform such a task to provide all the requirements for the field development problem.

Accordingly, there is a need for a field development planning framework that allows for consideration of the many variables required when planning development of a field, while consuming less time for field development engineers.

### SUMMARY OF THE INVENTION

It is to be understood that both the following general description and the following detailed description are exemplary and explanatory only and are not restrictive. Provided are systems and methods for field development decision optimization.

In one aspect, an apparatus for optimizing output of resources from a predefined field can comprise an Artificial Intelligence (AI)-assisted reservoir simulation framework configured to produce a performance profile associated with resources output from the field. The apparatus can further comprise an optimization framework configured for determining one or more financial constraints associated with the field, the optimization framework providing the one or more financial constraints to the AI-assisted reservoir simulation framework, and a deep learning framework configured for training a neural network for use by the optimization framework. The AI-assisted reservoir simulation framework determines, as an output, a plurality of actions for optimizing output of resources from the field.

In another aspect, a method for optimizing output of resources from a predefined field can comprise determining a time frame over which a field is to be developed and discretizing the time frame into a plurality of time steps. The method can further receive, as inputs, one or more financial constraints and one or more geological models. For each time step, an optimal action to be taken to generate an output of resources at the field can be determined based at least in part on the one or more financial constraints and the one or more geological models. Further, an optimal performance profile for the field can be determined based on the optimal actions to be taken to generate an output of resources at the field. Thereafter, the financial constraints are revised based on the optimal performance profile, and the steps of determining the optimal action to be taken and determining the optimal performance profile are repeated based on the revised financial constraints. In response to a lack of change in the optimal performance profile, the optimal performance profile and the optimal actions to be taken can be output.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a schematic diagram showing a system for optimizing output of resources from a predefined field; and

FIG. 2 is an example Artificial Intelligence-assisted reservoir simulation.

### DETAILED DESCRIPTION OF THE INVENTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for field development decision optimization. The field development can be divided into three main problems. First is a field planning problem, which involves determining financing and infrastructure for use in the field development. For example, field planning can involve setting a storage capacity, a number of wells to be drilled in a field, and the like. These decisions become constraints for additional problems. The field development further comprises a well placement problem. The well placement problem relates to the location and sequence of wells to be drilled, and also to the types of wells that are placed. Finally, field development can comprise a rate management (e.g., well control) problem, for establishing and varying flow rates at each well. These can include injection rates and/or productions rates.

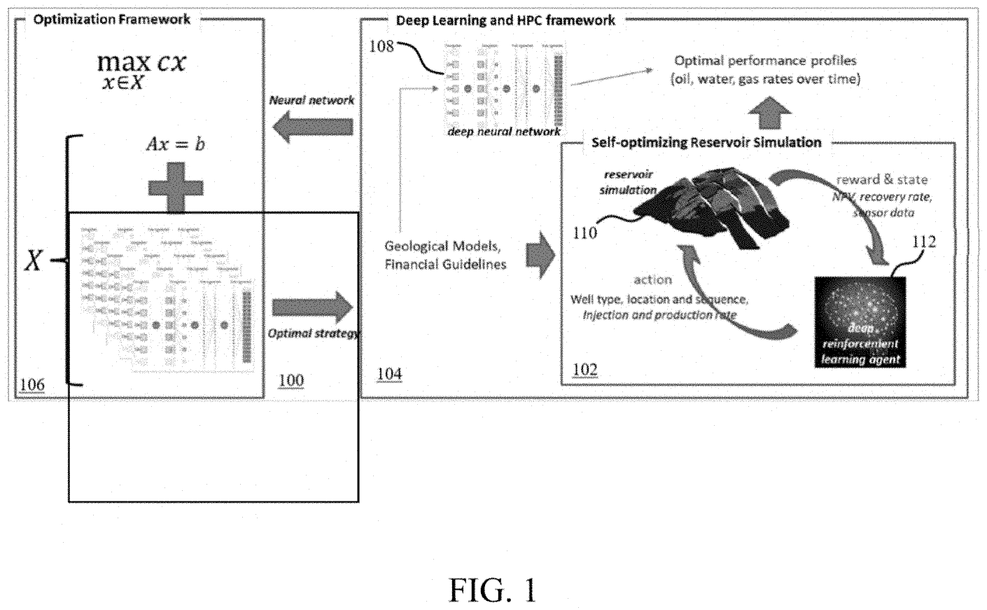

As shown in FIG. 1, a framework 100 for addressing each of the problems in the field development decision making has been created. The framework can be divided into three main parts: an AI-assisted reservoir simulation 102, a deep learning and high-performance computing (HPC) framework 104, and an optimization framework 106.

The AI-assisted reservoir simulation 102 receives, as input, one or more geological models. In some aspects, the AI-assisted reservoir simulation can optimize depletion planning and well management procedures, which helps to determine an optimal performance profile. The deep learning and HPC framework 104 can generate multiple perceivable and meaningful scenarios, and can execute simulations on a high performance computing platform. Based on a large amount of simulation data produced by the deep learning HPC framework 104, the framework 100 can construct one or more deep neural networks 108. The optimization framework 106 can be used to model development related variables and constraints along with deep neural networks 108 that represent reservoir performances to optimize the field development decisions. In some aspects, optimization can refer to one or more of maximizing production of a field (e.g., maximizing revenue derived from a field), maximizing monetary gain from the collected output of the field, minimizing costs associated with field development, and/or the like.

Reservoir simulation represents the subsurface characteristics of the field in a simulation environment. The goal of such a simulation is to mimic field development operations in the simulation to determine the output of the field in the simulation environment prior to actually developing the field. Decisions made in the simulation include where to place wells, and once the wells are placed, flow rates for each of the wells (e.g., injection rates to maintain pressure in the reservoir for injection wells, flow rates to maximize output for production wells, etc.).

Deep reinforcement learning can be used to optimize decisions associated with the reservoir simulation. The deep reinforcement learning agent operates a training phase prior to actual usage; wherein the deep reinforcement learning agent runs many simulations (e.g., comprising various geological models and constraints) to train a deep neural network to capture an optimal strategy. Thus, deep reinforcement learning runs many simulations to learn an optimal strategy. In an actual usage phase (e.g., when the deep reinforcement learning agent is used in the simulation), the deep reinforcement learning agent can observe a current state (e.g., reservoir states, including pressure and saturation observations and/or the like, production rates, etc.) and makes or suggests an optimal action using the trained deep neural network (e.g., based on its learning from the training). Using deep reinforcement learning for finding an optimal decision in reservoir simulation allows for running many simulations to learn reservoir dynamics, allowing for optimization of the decisions regarding well placement and flow rate management.

The AI-assisted reservoir simulation 102 can receive, as input, one or more geological models regarding the subsurface of the field to be developed. The AI-assisted reservoir simulation 102 can further receive financial guidelines that relate to an amount of money that can be spent on developing the field. In some aspects, the financial guidelines can be received from the optimization framework 106. The AI-assisted reservoir simulation 102 can generate a reservoir simulation 110 based on the input geological models and financial guidelines. The AI-assisted reservoir simulation 102 can further comprise a deep reinforcement learning agent 112 for determining a set of optimal decisions for field development. The deep reinforcement learning agent 112 can receive as input, information from the reservoir simulation. The received information can comprise, for example state information related to the state of the field (e.g., pressure and saturation measurements for subsurface fluids in the field), and reward information related to the field output (e.g., a cost of drilling a well, revenue of oil production, cost of water injection, etc.).

The deep reinforcement learning agent 112 can provide, as an output, an action to be taken in the reservoir simulation. For example, the action can comprise a well placement (location and type of well), and/or injection and production rates for existing wells. During a training phase, the output action can be used as an input to the reservoir simulation 110, forming a feedback loop that allows the deep reinforcement learning agent 112 to optimize the actions taken in the simulation. In an actual usage phase, at each time step in the simulation, the deep reinforcement learning agent 112 can observe the field state (e.g., pressure and saturation measurements for subsurface fluids in the field) and determine an optimal strategy. The optimal strategy determined by the deep reinforcement learning agent 112 can comprise adjusting controls (e.g., injection and/or production) for one or more existing wells and/or determining a location for one or more new wells. The output of the AI-assisted reservoir simulation 102 can comprise an optimal performance profile (e.g., the determined optimal strategy), specifying oil, water, and/or gas rates output from the field over time.

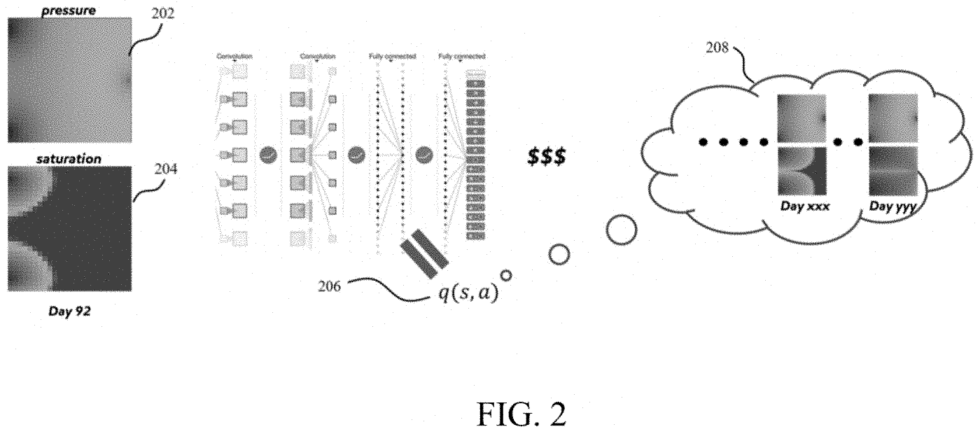

In some aspects, the state information can be received at the reservoir simulation as one or more images representing one or more features of the subsurface. FIG. 2 shows an example AI-assisted reservoir simulation. In some aspects, each of the one or more images can represent a different characteristic of the state of the field at a particular time t. As an example, FIG. 2 shows that the AI-assisted reservoir simulation can receive state information that comprises two images: a first image 202 representing pressure information in the subsurface, and a second image 204 representing saturation information in the subsurface. Each of the one or more received images 202, 204 can have a shape similar to the shape of the field, with each pixel of the image representing a corresponding area of the field. A color (e.g., hue, tint, tone, shade, etc.) can be used to represent intensity information related to the characteristic of the field represented in the image. For example, as shown in FIG. 2, the different colors of the first image 202 represent different pressures in the field subsurface, while the different colors of the second image 204 represent different saturations in the field subsurface.

The received one or more images 202, 204 can be processed to determine characteristic information of the field in the given state. The determined characteristic information can be used as input to a recurrent neural network. Outputs from the AI-assisted reservoir simulation during both the training phase and the actual usage phase can be as described above. As an example, during a training phase the output can comprise an action that can be used as an input to the reservoir simulation, forming a feedback loop that allows the deep reinforcement learning agent to optimize the actions taken in the simulation. In addition, the training phase can use generalization techniques such as image augmentation and the like to increase training variety. During the actual usage phase, the output can comprise an optimal performance profile (e.g., the determined optimal strategy), specifying oil, water, and/or gas rates output from the field over time. The output can further comprise a value of taking the specified action from in the current state (e.g., a function q(s, a)) 206, together with a predicted next state after taking the specified action 208. In particular, the deep reinforcement learning can receive the state (e.g., pressure, saturation, etc.) as images and predict the long term reward and the future states. In some aspects the output predicted next state can further comprise one or more figures, as shown in FIG. 2. Referring again to FIG. 1, the AI-assisted reservoir simulation 102 (e.g., the reservoir simulation 110 and the deep reinforcement learning agent 112) can be used to solve two problems: a depletion planning problem and a field management problem. In some aspects, the depletion planning problem and the field management problem can each be treated as a Markov decision process. In some aspects, each of the depletion planning problem and the field management problem can be treated as separate Markov decision processes. In other aspects, the depletion planning problem and the field management problem can be combined into a single Markov decision process. The Markov decision process provides a mathematical framework for modeling decision making in situations where outcomes are partly random and partly under the control of a decision maker.

The Markov decision process can be defined by a set (S, A, Pₐ, Rₐ, r), where S is a state; A is an action; Pₐ(s, s′) is the probability that an action is taken when the system is in state s at time t will lead to state s′ at time t+1 (that is, Pr(sₜ₊₁=s′|sₜ=s, aₜ=a)); Ra(s, s′) is the expected immediate reward received after transitioning from state s to state s′ by taking action a; and r is a discount fraction in the range of [0,1]. The goal is to find a policy function π(s) that specifies an action to take at state s that maximizes a cumulative function of the rewards

$${\sum }_{t = 0}^{∞} {r}^{t} {R}_{{a}_{t}}$$

where aₜ=π(sₜ) based on the policy. That is, the action aₜ taken at time t is determined based on the policy function π given the current state sₜ. To determine an optimal policy, reinforcement learning uses a value function:

$$Q ( s , a ) = {\sum }_{{s}^{t}} {P}_{a} ( s , {s}^{′} ) ( {R}_{a} + r {E}_{π} [ Q ( {s}^{′} , {a}^{′} ) ] ) .$$

The value function corresponds to taking the action a and then continuing according to the current policy. An optimal policy can be derived by maximizing the value function. For example, an optimal policy can be derived as

$$π ( s ) = \underbrace{arg max}_{a} Q ( s , a )$$

in situations where the argmax function is difficult to evaluate, function approximation techniques known in the art can be used. As one example, the function can be approximated using deep neural networks.

The depletion planning problem can be defined as a policy for when to place a well (e.g., at which time t), where to place a well, and what type of well should be placed (e.g., a producer well or an injector well). In some aspects, the producer and injector rate can be predetermined based on, for example, subsurface characteristics of the particular field. A time frame for the depletion process can be discretized into a plurality of discrete time steps of length N, and one or more decisions can be made at each time step. As a particular example, if the planning time frame is 180 days, the time frame can be discretized into 180 time steps, and one or more decisions can be made on a daily basis.

The state can represent a current status of the reservoir and planning. For example, a set of sensor measurements of the reservoir (e.g., pressure, saturation, velocity, and/or the like) and current well placement. This information can be derived, for example, from the reservoir simulation 110. In some aspects, information related to temporal evolution of the reservoir or field can be included in the state. The temporal relationship can be captured by including a current state and several past states, e.g., s′ₜ=[sₜ, sₜ₋ᵢ, sₜ₋₂, . . . , sₜ₋ₙ], or employing methods that directly or indirectly incorporate past state information, such as Hidden Markov model (HMM), recurrent neural network (RNN), and/or the like.

Actions for the model can be defined as a set including a well location and a well type. In some aspects, the well location can be chosen from a set of predetermined locations, creating a discrete (and finite) number of actions. In other aspects, the well location can be arbitrary, such that the well locations are specified using a coordinate system (e.g., x and y coordinates on a Cartesian plane, latitude and longitude coordinates, and the like), in which case the set of possible actions comprises a continuous (and thus infinite) number of possible actions. The well type can be selected from a group of well-known well types (e.g., producer, water or gas injector, etc.).

The reward can be a scalar value that represents both cost and revenue associated with a corresponding action. For example, the reward can represent the cost associated with drilling a well at a particular location, costs of injection, and revenue and/or treatment costs from oil, water and/or gas extracted from the field at the well location.

At each time step the deep reinforcement learning agent 112 can receive an updated state (e.g., a status of the reservoir) from the reservoir simulator, and the reward after taking the immediately previous action. Based on this information, the deep reinforcement learning agent 112 can produce, via the learned or determined policy, an output comprising an action to take (e.g., a well location and type), and conclude the current time step. There are states within the process which should result in termination of the process (e.g., when the state falls outside of predetermined normal operating characteristics). Such states are associated with a large negative reward. The assigned large negative reward is established to avoid catastrophic situations.

The field management problem can be defined as controlling flow rate of one or more wells to optimize production after the wells have been drilled. The Markov decision process formulation for the field management problem is very similar to the depletion planning problem except that the actions at each time step are the flow rates for each well.

As discussed above with respect to the depletion planning problem, a time frame for the depletion process can be discretized into a plurality of discrete time steps of length N, and one or more decisions can be made at each time step. As a particular example, if the planning time frame is 180 days, the time frame can be discretized into 180 time steps, and one or more decisions can be made on a daily basis.

The state can represent a current status of the reservoir. For example, a set of sensor measurements of the reservoir (e.g., pressure, saturation, velocity, and/or the like) and current well placement. This information can be derived, for example, from the reservoir simulation 110. In some aspects, information related to temporal evolution of the reservoir or field can be included in the state. The temporal relationship can be captured by including a current state and several past states, e.g., s′ₜ=[sₜ, sₜ₋ᵢ, sₜ₋₂, . . . , sₜ₋ₙ], or employing methods that directly or indirectly incorporate past state information, such as Hidden Markov model (HMM), recurrent neural network (RNN), and/or the like.

Actions for the model can be defined as pairs indicating a well from among the wells present in the field and an associated flow rates for the indicated well. In some aspects, the flow rate can be chosen from a set of predetermined rates, creating a discrete (and finite) number of actions. In other aspects, the flow rate can be arbitrary, in which case the set of possible actions comprises a continuous (and thus infinite) number of possible actions.

The reward can be a scalar value that represents both cost and revenue associated with a corresponding action. For example, the reward can represent the cost associated with altering a flow rate, costs of injection, and revenue and/or treatment costs from oil, water, and/or gas extracted from the field at the well location.

At each time step the deep reinforcement learning agent 112 can receive an updated state (e.g., a status of the reservoir) from the reservoir simulator, and the reward after taking the immediately previous action. Based on this information, the deep reinforcement learning agent 112 can produce, via the learned or determined policy, an output comprising an action to take (e.g., a well identifier and new flow rate for the well) and conclude the current time step. There are states within the process which should result in termination of the process (e.g., when sensor data falls outside of predetermined normal operating characteristics). Such states are associated with a large negative reward. The assigned large negative reward is established to avoid catastrophic situations.

As an alternative to solving the depletion problem and the field management problem separately, the depletion planning problem and the field management problem can be combined into a single Markov decision process and solved jointly. In such a process, the Markov decision process formulation remains similar, except the set of possible actions at each time can be expanded to include both drilling new well and changing the flow rate of one or more existing wells.

A time frame for the combined depletion and field management process can be discretized into a plurality of discrete time steps of length N, and one or more decisions can be made at each time step. As a particular example, if the planning time frame is 180 days, the time frame can be discretized into 180 time steps, and one or more decisions can be made on a daily basis.

As discussed in the Markov decision processes described above, the state can represent a current status of the reservoir. For example, a set of sensor measurements of the reservoir (e.g., pressure, saturation, velocity, and/or the like) and current well placement. This information can be derived, for example, from the reservoir simulation 110. In some aspects, information related to temporal evolution of the reservoir or field can be included in the state. The temporal relationship can be captured by including a current state and several past states, e.g., s′ₜ=[sₜ, sₜ₋ᵢ, sₜ₋₂, . . . , sₜ₋ₙ], or employing methods that directly or indirectly incorporate past state information, such as Hidden Markov model (HMM), recurrent neural network (RNN), and/or the like.

The set of actions for the model can comprise a set including a well location and a well type. The well location can be chosen from a set of predetermined locations, or can be arbitrary, such that the well locations is specified using a coordinate system (e.g., one or more of x and y coordinates on a Cartesian plane, latitude and longitude coordinates, and/or the like). The well type can be selected from a group of well-known well types (e.g., producer, water or gas injector, etc.). The set of actions can further include pairs indicating a well from among the wells present in the field and an associated flow rate for the indicated well. The flow rate can be chosen from a set of predetermined rates, or can be arbitrary.

The reward can be a scalar value that represents both cost and revenue associated with a corresponding action For example, the reward can represent the cost associated with drilling a well at a particular location, costs of injection, costs associated with altering a flow rate of a well, and revenue and/or treatment costs from oil, water, and/or gas extracted from the field at the well location.

At each time step the deep reinforcement learning agent 112 can receive an updated state (e.g., a status of the reservoir) from the reservoir simulator, and the reward after taking the immediately previous action. Based on this information, the deep reinforcement learning agent 112 can produce, via the learned or determined policy, an output comprising an actions to take (e.g., one or more of a well location and type, or a well identifier and new flow rate for the well) and conclude the current time step. There are states within the process which should result in termination of the process (e.g., when sensor data falls outside of predetermined normal operating characteristics). Such states are associated with a large negative reward. The assigned large negative reward is established to avoid catastrophic situations.

The proposed Markov decision process formulation provides a unified framework for both depletion planning and field management problems as well as for the combined problem. Moreover, the formulation provides tools for accommodating uncertainty. In some aspects, the uncertainty can be incorporated into the state transition probability as a function of one or more of the state and/or the one or more actions taken. Still further, the proposed Markov decision process formulation is not constrained by a steady-state model assumption and can easily be used to model a dynamic system.

The main purpose of the deep learning and HPC framework module 104 is to train the neural network 108 to mimic reservoir performances. The input of the neural network 108 is the financial investments over time (e.g., the financial constraints produced by the optimization framework 106), which can be used for well installations and operations. Since the simulation results contain many geological scenarios, the outputs become stochastic (e.g., random or pseudo-random) performances of the production profiles including oil, water, and/or gas production rates over time. The output from the neural network 108 can include minimum, maximum, and average production profiles, along with standard deviations of the production profile. The deep learning and HPC framework module 104 also includes data generation for the neural network trainings. It utilizes the parallel computing environments to generate scenarios and execute simulation runs. Once the neural network 108 is trained, the neural network can be provided to the optimization framework module 106 for use.

The optimization framework module 106 can optimize processes to help find development strategies that lead to optimal outcomes. For example, the optimization framework module 106 can use the neural network 108 trained by the deep learning and HPC framework 104 to determine financial guidelines for development. These financial guidelines can be provided to the AI-assisted reservoir simulation 102. The optimization model consists of two parts: a set of variables and constraints for the development planning; and neural networks that represent the expected responses, such as production profiles and resource requirements.

The variables can include when to invest in infrastructure elements (e.g., floating production storage and offloading units, pipelines, etc.), a size of each infrastructure element, and sequencing of development of regions. The constraints can be used to describe rules and conditions associated with each investment.

In some aspects, the optimization framework module 106 can receive, from the AI-assisted reservoir simulation 102, the optimal performance profile. As discussed above, the variables and constraints from the optimization framework 106 can be provided to the AI-assisted reservoir simulation framework 102 in the form of the financial guidelines. Accordingly, the optimization framework 106 and the AI-assisted reservoir simulation framework 102 form a larger feedback loop.

Once this larger feedback loop stabilizes, it can be determined that the framework 100 has reached an optimal solution (e.g., a solution that provides one or more of maximized production of a field (e.g., maximizing revenue derived from a field (e.g., maximized monetary gain from the collected output of the field), minimized costs associated with field development, and/or the like).

The neural network 108 can comprise a plurality of “neurons.” Each neuron can have a rectified linear activation function.

A solution of the optimization model can be validated in the reservoir simulation 110. If the results from the reservoir simulation 110 do not agree with the optimization prediction, the neural network used by the optimization framework 106 will be re-trained by the deep learning and HPC framework 104, providing a new neural network for the optimization model framework 106.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope. Other embodiments will be apparent to those skilled in the art from consideration of the specification and practice disclosed herein. It is intended that the specification and examples be considered as exemplary only, with a true scope being indicated by the following claims.

What is claimed is:

1. An apparatus for optimizing output of resources from a predefined field, comprising:
an Artificial Intelligence (AI)-assisted reservoir simulation framework configured to produce a performance profile associated with resources output from the field;
an optimization framework configured for determining one or more financial constraints associated with the field, the optimization framework providing the one or more financial constraints to the AI-assisted reservoir simulation framework; and
a deep learning framework configured for training a neural network for use by the optimization framework, wherein the AI-assisted reservoir simulation framework determines, as an output, a plurality of actions for optimizing output of resources from the field.

2. The apparatus of claim 1, wherein the AI-assisted reservoir simulation framework including a reservoir simulation in electronic communication with a deep reinforcement learning agent,
wherein the reservoir simulation provides, to the deep reinforcement learning agent, one or more attributes of the field, and
wherein the deep reinforcement learning agent provides, to the reservoir simulator, one or more actions to be performed on the field.

3. The apparatus of claim 2, wherein the deep reinforcement learning agent provides one or more actions to be performed on the field based on a policy function determined by a Markov decision process.

4. The apparatus of claim 2, wherein the one or more actions comprises a location at which a well should be drilled, and a type of well to be drilled.

5. The apparatus of claim 2, wherein the one or more actions comprises an identifier associated with a well and a flow rate to be associated with the identified well.

6. The apparatus of claim 2, wherein the neural network is validated against the reservoir simulation, and wherein in response to determining that the results from the reservoir simulation do not agree with the neural network, the neural network is re-trained by the deep learning and HPC framework.

7. A method comprising:
determining a time frame over which a field is to be developed;
discretizing the time frame into a plurality of time steps;
receiving, as inputs, one or more financial constraints and one or more geological models;
for each time step, determining, based at least in part on the one or more financial constraints and the one or more geological models, an optimal action to be taken to generate an output of resources at the field;
determining, based on the optimal actions to be taken to generate an output of resources at the field, an optimal performance profile for the field;
revising the financial constraints based on the optimal performance profile;
repeating the steps of determining the optimal action to be taken and determining the optimal performance profile; and
in response to a lack of change in the optimal performance profile, outputting the optimal performance profile and the optimal actions to be taken.

8. The method of claim 7, wherein the optimal action comprises identifying a location at which a well should be drilled, and a type of well to be drilled.

9. The method of claim 8, wherein the location is selected form a predetermined list of locations.

10. The method of claim 8, wherein the location is determined arbitrarily.

11. The method of claim 7, wherein the optimal action comprises identifying a well and adjusting a flow rate to be associated with the identified well.

12. The method of claim 7, wherein the step of revising the financial constraints comprises using the performance profile as input to a neural network, wherein the output of the neural network comprises the revised financial constraints.

13. The method of claim 12, wherein the step of determining the optimal action to be taken comprises:
determining, via a reservoir simulation, one or more attributes of the field based on the one or more geological models; and
determining, using deep reinforcement learning, an optimal action based at least in part on the attributes of the field from the reservoir simulation.

14. The method of claim 13, wherein the step of determining the optimal action further comprising determining the optimal action based on a policy function of a Markov decision process.
